(19) United States
(12) Patent Application Publication
(10) Pub. No.: US 2009/0253379 A1
(43) Pub. Date: Oct. 8, 2009

(54) Wireless data communications using low traffic channels of a frequency spectrum

(75) Inventor: Jason A. Trachewsky, Menlo Park, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/061,347

(22) Filed: Apr. 2, 2008

(51) Int. Cl. H04Q 7/20

(52) U.S. Cl. 455/68

(57) ABSTRACT

Provided is a wireless communication device in a communication system that utilizes unused wireless channels for wireless communications. The wireless communication device determines whether a channel within a frequency spectrum is unused. When the channel is unused, the communication device generates a generic signal in accordance with a frequency spectrum etiquette. The wireless communication device transmits the generic signal to indicate upcoming use of the channel, and in accordance with the frequency spectrum etiquette, transmits a protocol specific signal via the channel in accordance with a specific protocol of a plurality of specific protocols.

### BACKGROUND

1. Technical Field

The invention relates generally to communication systems and more particularly to data communication within a multiple protocol communication system using low traffic channels of a frequency spectrum.

2. Description of Related Art

Communication systems support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, et cetera, communicates directly or indirectly with other wireless communication devices.

For direct communications (also known as point-to-point communications), the participating wireless communication devices tune their receivers and transmitters to the same channel or channels (for example, one of the plurality of radio frequency (RF) carriers of the wireless communication system) and communicate over the channel(s).

For indirect wireless communications, each wireless communication device communicates directly with an associated base station (for example, for cellular services) and/or an associated access point (for example, for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (that is, a receiver and a transmitter) or is coupled to an associated radio transceiver (for example, a station for in-home and/or in-building wireless communication networks, RF modem, et cetera). The receiver is coupled to the antenna and includes a low noise amplifier, one or more intermediate frequency stages, a filtering stage, and a data recovery stage. The low noise amplifier receives inbound RF signals via the antenna and amplifies them.

The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

The transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

For both wireless and wireline communication systems, there are several standards specifications with protocols as to how audio, text, video, data, and/or any other type information is to be conveyed within the system. Communication devices that are designed to be compliant with a particular standard (for example, Ethernet 10Base-T, IEEE 802.11b, Bluetooth, et cetera) are able to communication with any other communication device within the communication system that is compliant with the same standard. For example, wireless communication devices that are compliant with IEEE 802.11b can communicate with each other, provided they are properly registered to the same communication system.

Differing communications standards sometimes use the same communication medium (for example, allocated radio frequency spectrum, wired connections, et cetera) due to a finite amount of communication medium. To illustrate, both Bluetooth and IEEE 802.11b use the 2.4 GHz spectrum. As long as communication systems that are compliant with differing standards share a communication medium and do not physically overlap, the systems can operate without interference from each other.

When the communication systems do physically overlap, however, they will interfere with each other and degrade the performance of both systems. For example, when a Bluetooth piconet physically overlaps with an IEEE 802.11b local area network, simultaneous use of the 2.4 GHz spectrum will cause interference that will most likely cause both transmissions to fail.

To help reduce this problem, communication devices have been developed to be compliant with multiple standards that have different protocols for a share communication medium. For example, wireless communication devices have been developed that are compliant with both Bluetooth and IEEE 802.11(a), (b), (g), and/or (n). In such devices, the Medium Access Control (MAC) layer of one protocol communications with the MAC layer of another protocol to avoid simultaneous use of the shared communication medium.

While this substantially reduces simultaneous use of a shared communication medium on a device-by-device basis, it does little to reduce simultaneous use on a communication system level. For example, if a first communication device desires to use the shared communication medium in accordance with a first protocol, it will block its use of a second protocol for the duration of the use per the first protocol; however, a second communication device may concurrently desire to use the shared communication medium in accordance with the second protocol. Because the protocols are different, the first device will obtain access of the share communication medium in accordance with the first protocol and the second device will obtain access of the shared communication medium in accordance with the second protocol. With both devices concurrently accessing the shared communication medium, their transmissions will again interfere with each other, causing at least one of the transmissions to fail.

Further, with increasing numbers of wireless communication devices in a communications system, when the channels of a frequency spectrum are congested with traffic from multiple devices deploy multiple specification protocols, transmission interference occurs even with transmissions having relatively little, though important, data content. An example of such interference is delay in being able to transmit while waiting for channels to clear of traffic. Another example is the delay of having to compete with other communication devices for the opportunity to transmit.

Therefore, a need exists for providing an alternative for data communication using congested or heavily-used channels of a frequency spectrums.

### SUMMARY

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWING(S)

FIG. 1 is a schematic block diagram illustrating a communication system in accordance with an embodiment of the present invention;

FIG. 2 is a schematic block diagram illustrating a wireless communication device in accordance with an embodiment of the present invention;

FIG. 3 illustrates a frequency spectrum with at least one channel;

FIG. 4 is a diagram illustrating a method for a communication device to use an unused channel for transmission purposes in accordance with an embodiment of the invention;

FIG. 5 is a logic diagram of a method for wireless data communications using low traffic channels of a frequency spectrum in accordance with an embodiment of the invention; and

FIGS. 6-8 illustrate logic diagrams of various embodiments for transmitting a generic signal to indicate upcoming use of the channel in accordance with an embodiment of the invention.

### DETAILED DESCRIPTION OF THE DRAWINGS

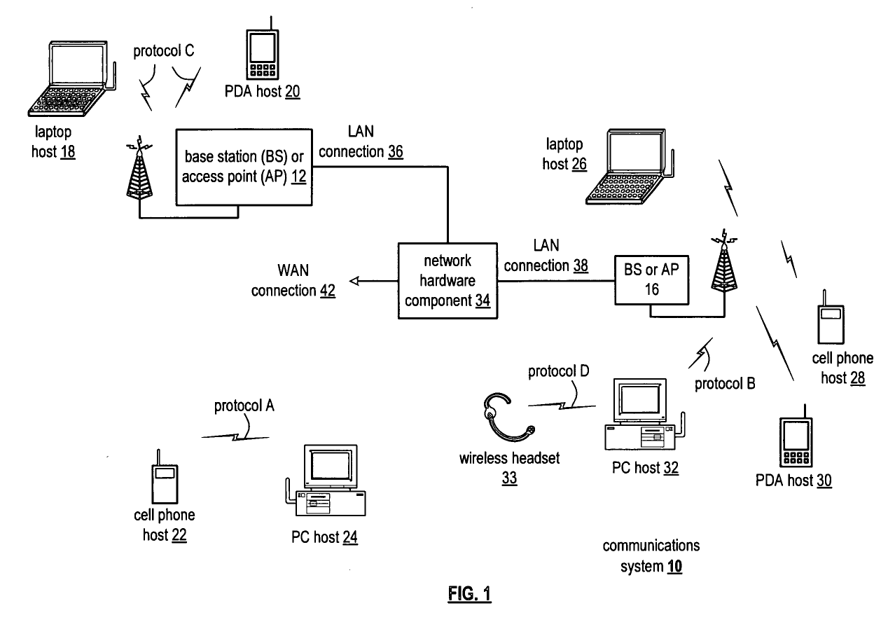

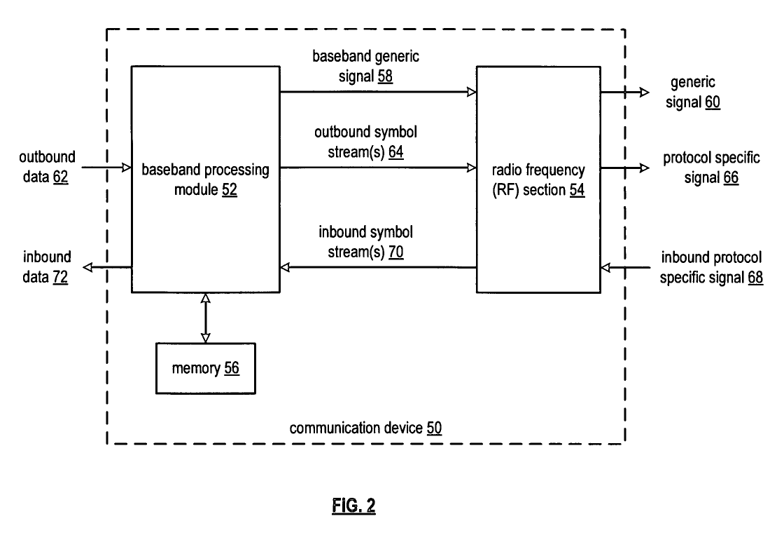

FIG. 1 is a schematic block diagram illustrating a communication system 10 that includes a plurality of base stations and/or access points 12 and 16, a plurality of wireless communication devices 18-33 and a network hardware component 34. The wireless communication devices 18-33 may be laptop host computers 18 and 26, personal digital assistant hosts 20 and 30, personal computer hosts 24 and 32, cellular telephone hosts 22 and 28, and/or wireless accessory devices, such as headset 33. The details of at least some of the wireless communication devices will be described in greater detail with reference to FIG. 2.

The base stations or access points 12 and 16 are operably coupled to the network hardware component 34 via local area network connections 36 and 38. The network hardware component 34, which may be a router, switch, bridge, modem, system controller, et cetera, provides a wide area network (WAN) connection 42 for the communication system 10.

Typically, base stations are used for cellular telephone systems and like-type systems, while access points are used for in-home or in-building wireless networks. Regardless of the particular type of communication system, each wireless communication device includes a built-in radio and/or is coupled to a radio. The radio includes a highly linear amplifier and/or programmable multi-stage amplifier as disclosed herein to enhance performance, reduce costs, reduce size, and/or enhance broadband applications.

Each of the base stations or access points 12 and 16 has an associated antenna or antenna array to communicate with the wireless communication devices in its regional area, which is generally referred to as a basic service set (BSS). The wireless communication devices register with a particular base station or access point 12 or 16 to receive services from the communication system 10.

Wireless communication devices 22 and 24 are located in an area of the wireless communication system 10 where they are not affiliated with an access point. In this region, which is generally referred to as an independent basic service set (IBSS), the wireless communication devices communicate directly (that is, point-to-point or point-to-multiple point), via an allocated channel to produce an ad hoc network.

Each of the wireless communication devices may support differing communications protocols within a given proximal area. For example, the protocols can include Personal Area Network (PAN) protocols (such as Bluetooth), and wireless local area networks protocols (such as IEEE 802.11a, 802.11b, 802.11g, 802.11n, et cetera).

In FIG. 1, the cell phone host 22 and the PC host 24 use protocol A to support wireless communications. The PC host 32 and the BS or AP 16 use protocol B to wireless communications, while the PC host 32 and the headset 33 use protocol D to wirelessly communicate with each other. Also, laptop host 18 and PDA host 20 each use protocol C to wirelessly communicate with the BS or AP 12.

Each of these communication devices, in general, communicate by a data broadcast intended for a specified destination. In the alternative, devices can deploy beam forming techniques to direct transmission energy towards an intended recipient.

Regardless of the wireless transmission technique, some level of interference to non-party devices will likely occur. Transmission interference is further increased by communications devices using different protocols in close proximity to each other. Further, wireless channel congestion also increases with devices transmitting large amounts of data that cause the channels to be unavailable for a relatively long period of time. The resulting wireless channel congestion slows and/or interferes with data communications between other communication devices.

To alleviate the interference cause by heavy channel traffic, one or all of the devices 18-33 are capable of conducting wireless communications in unused channels, which do not have regular data traffic that are apart from those allocated principally for data communications in the communications system 10. In some instances, these may be channels within an “unlicensed spectrum,” such as the 57-66 GHz spectrum.

The transmissions types contemplated for these unused wireless channels have lower data rates and lower data content—that is, these transmission types have a sufficiently small duration to permit a communication device to transmit over a discrete, specified time slot within the unused channel. In this manner, when wireless channels within the frequency spectrum commonly used for data transmissions (that is, a “licensed spectrum”) are heavily congested (such as by numerous large data transmissions and/or a large number of wireless communication devices with the same or dissimilar protocols), faster, discrete data communications may take place concurrently over unused wireless channels. Further detailed discussion of implementing such wireless communications over low traffic channels is provided with respect to FIGS. 2-8.

FIG. 2 is a schematic block diagram illustrating a wireless communication device 50 that includes the host device 18-33. For cellular telephone hosts, the communication device is a built-in component. For personal digital assistants hosts, laptop hosts, personal computer hosts, wireless accessory devices, the communication device 50 may be a built-in or an externally coupled component. In this embodiment, the station may be compliant with one of a plurality of wireless local area network (WLAN) including, but not limited to, IEEE 802.11b, IEEE 802.11g, IEEE 802.11n, et cetera, and/or wireless personal area network (WPAN) protocols including, but not limited to, Bluetooth, ZigBee, et cetera.

The communication device 50 includes a baseband processing module 52, memory 56, a radio frequency (RF) section 54 having a transmitter portion, which may further include plurality of radio frequency (RF) transmitters, and having a receiver portion, which may further include a plurality of RF receivers. For data communications, the communication device 50 may interacts with a transmit/receiver (T/R) module and a plurality of antennas to facilitate wireless communications with between wireless communications devices.

The baseband processing module 52, in combination with operational instructions stored in memory 56, executes digital receiver functions and digital transmitter functions, respectively. The digital receiver functions include, but are not limited to, digital intermediate frequency to baseband conversion, demodulation, constellation demapping, decoding, de-interleaving, fast Fourier transform, cyclic prefix removal, space and time decoding, and/or descrambling. The digital transmitter functions include, but are not limited to, scrambling, encoding, interleaving, constellation mapping, modulation, inverse fast Fourier transform, cyclic prefix addition, space and time encoding, and/or digital baseband to IF conversion.

The baseband processing modules 52 may be implemented using one or more processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

The memory 56 may be a single memory device or a plurality of memory devices. Such a memory device may be a read-only memory, random access memory, volatile memory, non-volatile memory, static memory, dynamic memory, flash memory, and/or any device that stores digital information. Note that when the baseband processing module 52 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

As one of average skill in the art will appreciate, the wireless communication device 50 may be implemented using one or more integrated circuits. The baseband processing module 52 and memory 56 may be implemented on a first integrated circuit, and the RF section 54, less antenna(s), may be implemented on a second integrated circuit. As an alternate example, the communication device 50 may be implemented on a single integrated circuit including the baseband processing module 52, memory 56, and RF section 54.

In operation, the communication device 50 receives outbound data 62 and produces one or more outbound symbol streams 64 or a baseband generic signal 58. The baseband processing module 52 may operate in a number of modes, based upon a mode selection input. For example, based upon a mode selection input, the baseband processing module 52 may operate at a frequency band of 2.4 GHz, a channel bandwidth of 20 or 22 MHz and a maximum bit rate of 54 megabits-per-second. In this general category, the baseband processing module 52 may further operate at a data rate ranging from 1 megabit-per-second to 54 megabits-per-second. In addition, the baseband processing module 52 will operate at a particular modulation type, which includes, but is not limited to, Barker Code Modulation, BPSK, QPSK, CCK, 16 QAM and/or 64 QAM.

The baseband processing module 52 produces the one or more outbound symbol streams 64 from the outbound data 62. For example, if the baseband processing module 52 is operates in a single transmit antenna mode, the baseband processing module 52 will produce a single outbound symbol stream 64. Alternatively, if the baseband processing module 52 is operating in a 2-, 3- or 4-antenna mode, the baseband processing module 52 will produce 2-, 3- or 4-outbound symbol streams 64 corresponding to the number of antennas from the outbound data 62.

Depending on the number of outbound streams 64 produced by the baseband module 52, a corresponding number of the RF transmitters 68-72 from the RF section 54 will be enabled to convert the outbound symbol streams 64 into protocol specific signals 66, which are provided to a corresponding antenna for transmission.

When the communication device 50 is in a receive mode, RF receivers of the RF section 54 receive the inbound protocol specific signal 68. The RF receivers convert the inbound protocol specific signal 68 into a corresponding number of inbound symbol streams 70. The number of inbound symbol streams 70 will correspond to the particular mode in which the data was received. The baseband processing module 52 receives the inbound symbol streams 70 and converts them into inbound data 72.

When a channel within a frequency spectrum is unused, the baseband processing module 52 generates a baseband generic signal 58. The RF section 54 receives and produces a generic signal 60. The generic signal 58 is generated in accordance with a frequency spectrum etiquette—that is, communication device “conduct” or “procedure” required for wireless communications devices of the communications system 10 that is marked by the appearance of consideration, tact, deference, and/or courtesy with respect to neighboring communication devices.

In operation, the communication device 50 transmits the generic signal to indicate upcoming use of the channel. In accordance with the frequency spectrum etiquette, the communications device 50 transmits a protocol specific signal 66 via the channel in accordance with a specific protocol of a plurality of specific protocols, such as those conforming to European Computer Manufacturer's Association (ECMA) protocol specifications, Institute of Electrical and Electronics Engineers (IEEE) 802.15.3.c protocol specifications, Next Generation millimeter-wave Standardization group (NGmS) protocol specifications, Wireless High Definition (HD) protocol specifications, IEEE 802.11 Very High Throughput (VHT) protocol specifications, et cetera.

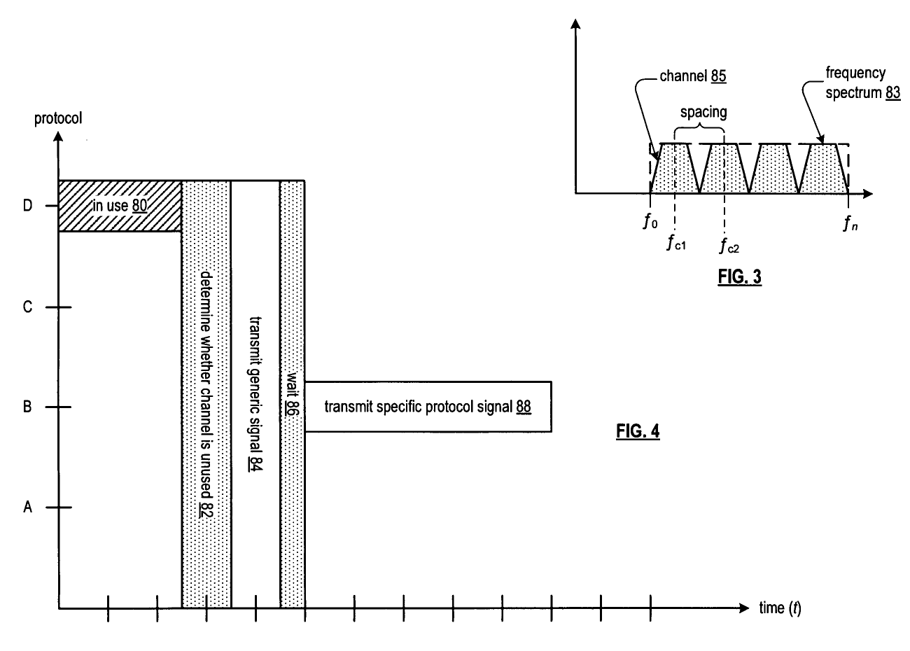

FIG. 3 illustrates a frequency spectrum 83 that includes at least one channel 85. The frequency spectrum 83 may also be referred to as an “unlicensed spectrum.” An example is in 57-66 GHz frequency range. The channel 85 is considered an “unused channel” because it lacks consistent data communication traffic. In this regard, the wireless communications devices 18-33 may engage in data communications, and avoid high-traffic, or “used,” channels to transact brief and succinct data transmissions.

The channels within the frequency spectrum 83 have an associated spacing. For example, in the 57-66 GHz spectrum, the channels have a 2.160 GHz spacing, with the center frequencies, f_{center}, beginning at 58.240 GHz.

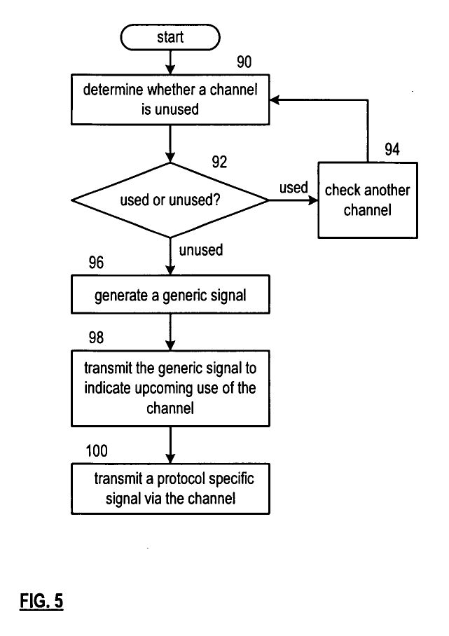

FIG. 4 is a timing interval diagram illustrating a method for a communication device 50 to use an unused channel for transmission purposes. The wireless communications devices 18-33 have the ability to receive and interpret a generic signal, and know that the unused channel, such as channel 85, will be used for a period of time, which is fixed or as otherwise specified (such as through a wireless communications specification). The devices 18-22 of the communications system 10 use protocols A, B, C, and D, respectively.

On a per channel basis, a wireless communication device may transmit a specific protocol signal at interval 88. For example, at interval 80, a wireless communication devices using protocol D for communication (that is, the wireless headset 33 and the PC host 32) is using the channel.

One of the wireless communication devices using protocol B (that is, PC host 32 and BS or AP 16) is waiting for an opportunity to transmit data over the channel. The wireless communication device monitors the channel, and determines that the channel is unused at interval 82.

A wireless communication device may determine whether the channel is unused by detecting the energy of the channel for a given time period, such as with a received signal strength indication (RSSI). When the energy of the channel compares favorably to an energy threshold level, such as when no signal energy is sensed on the channel for a predetermined time period, the wireless communication device transmits a generic signal at interval 84.

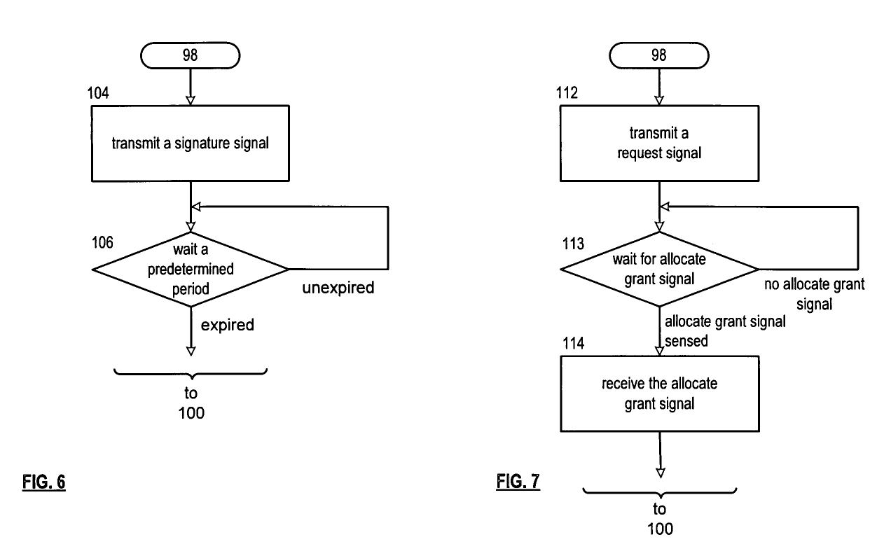

The generic signal is a signal in accordance with an etiquette of the frequency spectrum 83. Discussion of the generic signal is discussed in further detail with respect to FIGS. 5-8. Following transmission of the generic signal at interval 84, the wireless communication device waits a predetermined time period at interval 86. Following expiration of the predetermined time period, the wireless communication device transmits a protocol specific signal at 88. The protocol specific signal is in accordance with a specific protocol of a plurality of specific protocols, such as those including European Computer Manufacturers Association (ECMA) based protocol specifications, IEEE 802.15.3 protocol specifications, Next Generation millimeter-wave Standardization group (NGmS) protocol specifications, Wireless High Definition (HD) protocol specifications, IEEE 802.11 Very High Throughput (VHT) protocol specifications, et cetera.

The wireless communication device may transmits the protocol specific signal over a fixed time period provided at interval 88. The fixed time period is selected in accordance with the frequency spectrum etiquette.

Such a transmission over an unused wireless channel provides several benefits. First, transmissions over such a channel makes use of an unused resource. Second, provides an alternative to higher traffic channels in “licensed” spectrums for comparatively shorter or concise data transmissions. Third, the generic signal indicates to other devices in the communication system 10 that a wireless communication device is going to be using the channel for a predetermined period—increasing the probability that the channel will be available for the predetermined period, and that other devices will respect the etiquette to such usage.

FIG. 5 is a logic diagram of a method performed by the communication device 50 (see FIG. 2) for wireless data communications using low traffic channels of a frequency spectrum. The method begins at Step 90 where the communication device determines whether a channel is unused. When, at Step 92, the channel is used, the communication device checks another channel at Step 94 and determines whether that channel is unused at Step 90.

When, at Step 92, the channel is unused, the communication device generates a generic signal at Step 96, and at Step 98, transmits the generic signal to indicate upcoming use of the channel. The communication device may generate the generic signal by generating a generating a Gaussian minimum shift keying (GMSK) modulated generic signal, by generating a filtered π/2 Binary Phase Shift Keying (BPSK) modulated generic signal, by generating a BPSK modulated generic signal, et cetera.

A BPSK modulated signal may be a π/2 BPSK signal, a π/2 phase-rotated BPSK, or a combination thereof. The symbols of a π/2 BPSK signal is either +1 or −1 on the real axis. The symbols of a π/2 phase-rotated BPSK is either +j or −j on the imaginary axis. In an example of a BPSK generic signal including both BPSK forms, the first symbol is either +1 or −1, the next symbol is either +j or −j, et cetera. Other variations may be implemented.

The generic signal is based on a frequency spectrum etiquette, which is a protocol for the communication device to access the unused channel, such as in an unlicensed spectrum.

The frequency spectrum etiquette is based upon acceptable wireless transmission protocol rules and conventions that regulate behavior for the communication devices participating in a network. Some or all of the communication devices in the network possess an etiquette protocol to participate in the unlicensed spectrum, in which each of the participating devices has an behavior expected from it toward other devices and from other devices to itself. In effect, the frequency spectrum etiquette serves to increase the probability that the channel will be available for its use during a predetermined period.

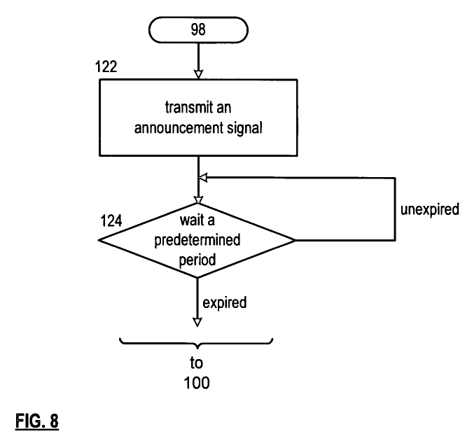

For example, when the transmission practices are directed towards achieving short, concise data communications, the generic signal, which is based upon the frequency spectrum etiquette, indicates to other wireless communication devices that the channel is going to be used for a predetermined period. In response, the spectrum frequency etiquette is that the other wireless communication devices would at a minimum respect the announcement, and defer to the announcing wireless communication device's transmission over the predetermined period. In this manner, a level of cooperation can be achieved between the wireless communication devices towards use of an otherwise unused or low traffic resource. Transmission of the generic signal may be performed as further described with respect to FIGS. 6-8.

Following the transmission of the generic signal, the communication device transmits a protocol specific signal via the channel at Step 100.

FIGS. 6-8 illustrate logic diagrams of various embodiments for transmitting a generic signal to indicate upcoming use of the channel.

FIG. 6 is a logic diagram of one method that may be utilized by the communication device 50 to transmit a generic signal to indicate upcoming use of the channel. At Step 104, the communication device transmits a signature signal, and waits a predetermined period at Step 106. The wait period allows the signature signal to be detected and/or received by other wireless communication devices of the communication system, and upon expiration, the communication device 50 has the presumption that it will have uninterrupted access to the channel to transmit the specific protocol signal. The signature signal includes a chirp signal, a CAZAC signal, a Golay sequence, et cetera.

While the predetermined period is unexpired, the communication device continues to wait. Upon expiration, the method continues to Step 100 (see FIG. 5), in which the communication device transmits a protocol specific signal via the channel.

FIG. 7 is a logic diagram of another method that may be utilized by the communication device 50 to transmit a generic signal to indicate upcoming use of the channel. At Step 112, the communication device transmits a request signal. The communication device then expects, in response, an allocate grant signal. Accordingly, the communication device waits for an allocate grant signal at Step 113. When no allocate grant signal during a predetermined period, the communication device continues to wait. Otherwise, at Step 113, the allocate grant signal is sensed, and at Step 114 is received. After receiving the allocated grant signal, the method returns to Step 100, in which the communication device transmits the protocol specific signal.

FIG. 8 is a logic diagram of yet another method that may be utilized by the communication device 50 to transmit a generic signal to indicate upcoming use of the channel. At Step 122, the communication device transmits an announcement signal, and waits a predetermined period at Step 124.

The announcement signal includes information regarding the data that is to follow via the protocol specific signal. For example, the announcement signal includes a frame format with a preamble, header, and payload. The preamble includes information for a communication device to detect the frame, and information for a receiving device to demodulate and decode the announcement frame. The header is a broadcast frame (that is, one that is broadcast to all wireless communication devices and AP or BS within the communication system 10), which has data rate and payload information (such as size, modulation type, et cetera). The payload includes allocation information, such as the IP address of the destination device within the communication system 10.

The wait period allows the announcement signal to be detected and/or received by other wireless communication devices of the communication system, and upon expiration, the communication device 50 has the presumption that it will have uninterrupted access to the channel to transmit the specific protocol signal.

While the predetermined period is unexpired, the communication device continues to wait. Upon expiration, the method continues to Step 100 (see FIG. 5), in which the communication device transmits a protocol specific signal via the channel.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (for example, an item includes, but is not limited to, a component, an element, a circuit, and/or a module) where, for indirect coupling, the intervening item does not modify the information of a signal but may adjust its current level, voltage level, and/or power level. As may further be used herein, inferred coupling (that is, where one element is coupled to another element by inference) includes direct and indirect coupling between two items in the same manner as “coupled to”. As may even further be used herein, the term “operable to” indicates that an item includes one or more of power connections, input(s), output(s), et cetera, to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, et cetera, provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

What is claimed is:

1. A method comprises:
determining whether a channel within a frequency spectrum is unused;
when the channel is unused, generating a generic signal in accordance with a frequency spectrum etiquette;
transmitting the generic signal to indicate upcoming use of the channel; and
in accordance with the frequency spectrum etiquette, transmitting a protocol specific signal via the channel in accordance with a specific protocol of a plurality of specific protocols.

2. The method of claim 1, wherein the transmitting the generic signal comprises:
transmitting a signature signal;
waiting a predetermined time period after transmitting the signature signal; and
after expiration of the predetermined time period, transmitting the protocol specific signal.

3. The method of claim 1, wherein the transmitting the generic signal comprises:
transmitting a request signal;
receiving an allocate grant signal; and
after receiving the allocated grant signal, transmitting the protocol specific signal.

4. The method of claim 1, wherein the transmitting the generic signal comprises:
transmitting an announcement signal; and
waiting a predetermined time period after transmitting the announcement signal;
after expiration of the predetermined time period, transmitting the protocol specific signal.

5. The method of claim 1 further comprises:
transmitting the protocol specific signal within a fixed time period following the transmitting the generic signal, wherein the fixed time period is set in accordance with the frequency spectrum etiquette.

6. The method of claim 1, wherein the determining whether the channel is unused comprises:
detecting energy of the channel for a given time period; and
when the energy of the channel compares favorably to an energy threshold level, determining that the channel is unused.

7. The method of claim 1 further comprises:
the frequency spectrum including a 57-66 GHz frequency spectrum; and
the plurality of specific protocols including at least two of European Computer Manufacturer's Association (ECMA), Institute of Electrical and Electronics Engineers (IEEE) 802.15.3.c, Next Generation millimeter-wave Standardization group (NGmS), Wireless High Definition (HD), and IEEE 802.11 Very High Throughput (VHT) specifications.

8. The method of claim 1 further comprises, when the channel is used:
determining whether another channel within the frequency spectrum is unused;
when the another channel is unused, generating the generic signal in accordance with the frequency spectrum etiquette;
transmitting the generic signal to indicate upcoming use of the another channel; and
in accordance with the frequency spectrum etiquette, transmitting the protocol specific signal via the another channel in accordance with the specific protocol.

9. The method of claim 1, wherein the generating the generic signal comprises at least one of:
generating a Gaussian Minimum Shift Keying (GMSK) modulated generic signal;
generating a filtered π/2 Binary Phase Shift Keying (BPSK) modulated generic signal; and
generating a BPSK modulated generic signal.

10. An apparatus comprises:
memory; and
a processing module coupled to the memory, wherein the processing module functions to:
determine whether a channel within a frequency spectrum is unused;
when the channel is unused, generate a generic signal in accordance with a frequency spectrum etiquette;
transmit the generic signal to indicate upcoming use of the channel; and
in accordance with the frequency spectrum etiquette, transmit a protocol specific signal via the channel in accordance with a specific protocol of a plurality of specific protocols.

11. The apparatus of claim 10, wherein the processing module further functions to transmit the generic signal by:
transmitting a signature signal; and
waiting a predetermined time period after transmitting the signature signal;
after expiration of the predetermined time period, transmitting the protocol specific signal.

12. The apparatus of claim 10, wherein the processing module further functions to transmit the generic signal by:
transmitting a request signal;
receiving an allocate grant signal; and
after receiving the allocated grant signal, transmitting the protocol specific signal.

13. The apparatus of claim 10, wherein the processing module further functions to transmit the generic signal by:
transmitting an announcement signal; and
waiting a predetermined time period after transmitting the announcement signal;
after expiration of the predetermined time period, transmitting the protocol specific signal.

14. The apparatus of claim 10, wherein the processing module further functions to:
transmit the protocol specific signal within a fixed time period following the transmitting the generic signal, wherein the fixed time period is set in accordance with the frequency spectrum etiquette.

15. The apparatus of claim 10, wherein the processing module further functions to determine whether the channel is unused by:
detecting energy of the channel for a given time period; and
when the energy of the channel compares favorably to an energy threshold level, determining that the channel is unused.

16. The apparatus of claim 10, wherein the processing module further functions to, when the channel is used:
determine whether another channel within the frequency spectrum is unused;
when the another channel is unused, generate the generic signal in accordance with the frequency spectrum etiquette;
transmit the generic signal to indicate upcoming use of the another channel; and
in accordance with the frequency spectrum etiquette, transmit the protocol specific signal via the another channel in accordance with the specific protocol.

17. The apparatus of claim 10, wherein the processing module further functions to generate the generic signal by at least one of:
generating a GMSK (Gaussian minimum shift keying) modulated generic signal;
generating a filtered π/2 BPSK (Binary Phase Shift Keying) modulated generic signal; and
generating a BPSK modulated generic signal.

18. The apparatus of claim 10 further comprises:
a baseband processing module coupled to:
generate a baseband generic signal in accordance with a generic protocol;
convert outbound data into an outbound symbol stream in accordance with the specific protocol; and
convert an inbound symbol stream into inbound data in accordance with the specific protocol; and
a radio frequency (RF) section coupled to:
convert the baseband generic signal into the generic signal;
convert the outbound symbol stream into the protocol specific signal; and
convert an inbound protocol specific signal into the inbound symbol stream.
